(19) United States
(12) Patent Application Publication
(10) Pub. No.: US 2008/0106560 A1
(43) Pub. Date: May 8, 2008

(54) Printing system, print management apparatus, printing method and computer readable medium

(75) Inventor: Toshihiko Shibusawa, Kawasaki-shi (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 11/882,832

(22) Filed: Aug. 6, 2007

(30) Foreign Application Priority Data
Nov. 8, 2006 (JP) 2006-302681

(51) Int. Cl. B41J 29/38

(52) U.S. Cl. 347/14

(57) ABSTRACT

The printing system is provided with: an image forming unit including a usage restriction of a predetermined print attribute set in print data for performing a print operation; a release character string receiving unit that receives input of a release character string for releasing the usage restriction of the print attribute included in the image forming unit within an effective range given in advance; and a usage restriction releasing unit that releases the usage restriction of the image forming unit on condition that the release character string received in the release character string receiving unit has effect of releasing the usage restriction of the print attribute included in the image forming unit.

### CROSS REFERENCE TO RELATED APPLICATIONS

This application is based on and claims priority under 35 USC §119 from Japanese Patent Application No. 2006-302681 filed Nov. 8, 2006.

### BACKGROUND

1. Technical Field

The present invention relates to a printing system in which a printer is connected to a terminal, a print management apparatus, a printing method, and a computer readable medium.

2. Related Art

Recently, a printing system in which one or plural terminals and one or plural printers are connected via a network such that one or plural printers are shared or are selected from one or plural terminals has been configured, for example, in offices.

Among such printing systems, there is a printing system that is configured to manage a use of a printer. For example, a management server that manages the use of the printer on a network is installed, and information (user management information) on a usable range of various printing functions set by each user is stored in the management server. In addition, when a user performs a print operation using a specific printing function, the use of the specific printing function is permitted or prohibited on the basis of the user management information stored in the management server.

### SUMMARY

According to an aspect of the invention, there is provided a printing system having: an image forming unit including a usage restriction of a predetermined print attribute set in print data for performing a print operation; a release character string receiving unit that receives input of a release character string for releasing the usage restriction of the print attribute included in the image forming unit within an effective range given in advance; and a usage restriction releasing unit that releases the usage restriction of the image forming unit on condition that the release character string received in the release character string receiving unit has effect of releasing the usage restriction of the print attribute included in the image forming unit.

### BRIEF DESCRIPTION OF THE DRAWINGS

Exemplary embodiment(s) of the present invention will be described in detail based on the following figures, wherein:

FIG. 1 is a diagram illustrating the overall configuration of a printing system according to a first exemplary embodiment;

FIG. 2 is a block diagram illustrating the functional configuration of the client PC;

FIG. 3 is a block diagram illustrating the functional configuration of the management server;

FIG. 4A is a diagram illustrating an example of information to manage the electronic coupon given in response to the user identifying information stored in the user information management table;

FIG. 4B is a diagram illustrating an example of information on the printing function for which the usage restriction is released by the electronic coupon and the effective range set in the electronic coupon stored in the electronic coupon management table;

FIG. 5A is a diagram illustrating an example of information to manage the non-specified electronic coupon of which the user identifying information stored in the user information management table is not specified;

FIG. 5B is a diagram illustrating an example of information on the printing function for which the usage restriction is released by the non-specified electronic coupon and the effective range set in the electronic coupon stored in the electronic coupon management table;

FIG. 6A is a diagram illustrating an example of information for the management of the electronic coupon given in response to the user identifying information stored in the user information management table;

FIG. 6B is a diagram illustrating an example of information on the printing function for which the usage restriction is released by the electronic coupon and the effective range set in the electronic coupon stored in the electronic coupon management table;

FIG. 7 is a block diagram illustrating the functional configuration of the plural printers;

FIGS. 8 and 9 are flowcharts illustrating an example of a process sequence of the print operation in the printing system according to the first exemplary embodiment;

FIG. 10 is a diagram illustrating an example of the print setup dialog box displayed on the display unit;

FIG. 11 is a diagram illustrating the overall configuration of the printing system according to the second exemplary embodiment;

FIG. 12 is a block diagram illustrating the functional configuration of the copy machine according to the second exemplary embodiment;

FIG. 13 is a block diagram illustrating the functional configuration of the management server; and

FIG. 14 is a flowchart illustrating an example of a process sequence of the copy operation in the printing system according to the second exemplary embodiment.

### DETAILED DESCRIPTION

Hereinafter, exemplary embodiments of the invention will be described in detail with reference to the drawings.

### First Exemplary Embodiment

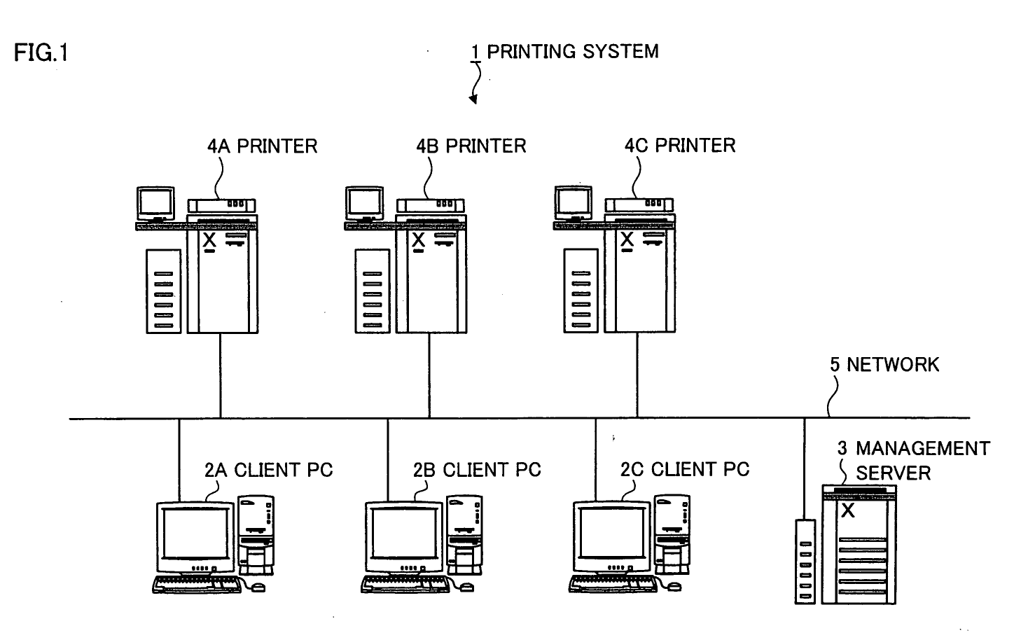

FIG. 1 is a diagram illustrating the overall configuration of a printing system 1 according to a first exemplary embodiment. In the printing system 1 shown in FIG. 1, for example, plural client PCs (personal computers) 2 (2A to 2C) installed in a user's work space (for example, desk), plural printers 4 (4A to 4C) to print document data generated in the client PCs 2 on a medium such as print paper (hereinafter, referred to as “paper”), and a management server (a print management apparatus) 3 that manages the use of the printer 4 by the client PC 2 are configured to be connected via a network 5 such as LAN (Local Area Network), WAN (Wide Area Network), or Internet using the communication lines and cables such that interactive communication is possible. Here, the client PC 2 is an example of a terminal (terminal device) and the printer 4 is an example of an image forming unit (image forming apparatus). A communication line may include a telephone line or a satellite communication channel (for example, a spatial transmission channel of digital satellite broadcasting). In the printing system 1 according to the first exemplary embodiment, the plural client PCs 2 and the plural printers 4 are connected on the network 5. Three client PCs 2A to 2C and three printers 4A to 4C are connected as an example in the configuration as shown in FIG. 1.

A client PC 2 has a function of preparing or storing document data including a document, a figure, a picture, and the like. In addition, when the prepared document data, the stored document data, or the like are printed, the client PC 2 instructs a printer 4 designated for performing a print operation to print the document data via the management server 3. When a usage restriction of specific one or plural printing functions are set in the printer 4 designated for performing the print operation, the client PC 2 receives input of a release character string (hereinafter, referred to as “an electronic coupon”) which releases the usage restriction set in the printing function within a effective range set in advance, and input of user identification information which identifies a user. And then, the client PC 2 instructs the printer 4 designated for performing the print operation to print the document data, and sends the electronic coupon and the user identifying information to the printer 4 as well.

That is, the printing system 1 according to the first exemplary embodiment is configured so as to use the specific printing function by using the electronic coupon according to each print job like a ticket, since the effect of releasing the usage restriction of the specific printing function is given to each electronic coupon with limiting the effective range.

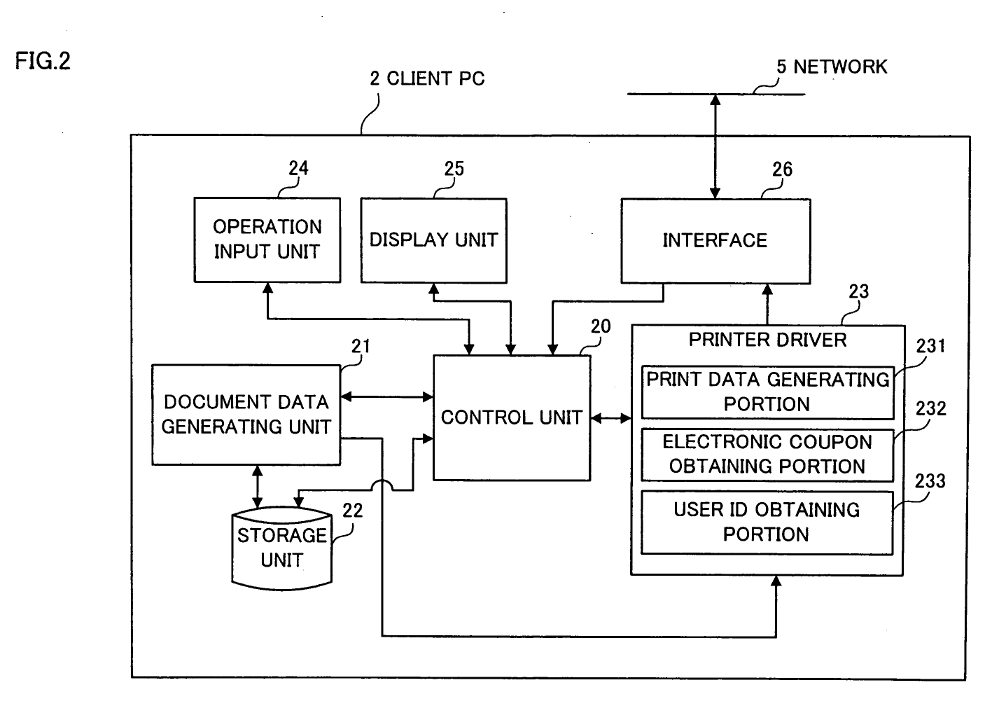

FIG. 2 is a block diagram illustrating the functional configuration of the client PC 2. As shown in FIG. 2, the client PC 2 includes a control unit 20, a document data generating unit 21, a storage unit 22, a printer driver 23, an operation input unit 24, a display unit 25, and an interface 26.

The control unit 20 controls the entire operation of the client PC 2 in accordance with a predetermined control program.

The document data generating unit 21 generates the document data including a document, a figure, a picture, or the like or edits the stored document data in accordance with a predetermined application software, or the like.

The storage unit 22 may be configured as, for example, a hard disk drive. The storage unit 22 stores and saves the document data, programs, or the like.

The operation input unit 24 may be configured as, for example, pointing devices such as a keyboard and a mouse. The operation input unit 24 receives various inputs from a user. For example, the operation input unit 24 receives the input of designation of the printer 4 or setup of various printing functions (hereinafter, referred to as “print attributes”) at the time of printing, the input of the electronic coupon (a release character string) having keywords or the like including plural character strings that release the usage restriction set in response to the specific printing function within the effective range set in advance, the input of the user identifying information having character strings (for example, a user ID, a password, and the like) or the like identifying a user and the like. In this case, the inputted electronic coupons are distributed from the management server 3 to each user in advance and are set in response to the user identifying information of each user.

The display unit 25 is an example of a display. For example, the display unit 25 may be configured as a liquid crystal display or the like. The display unit 25 displays document data, a print setup dialogue box which is a printing function setup unit for inputting a setup of various printing functions (print attributes) at the time of printing, and the like. The interface 26 controls a communication with a network 5.

A printer driver 23 includes a print data generating portion 231 that generates the print data, an electronic coupon obtaining portion 232, and a user ID obtaining portion 233.

The electronic coupon obtaining portion 232 obtains the electronic coupon inputted from the operation input unit 24. The user ID obtaining portion 233 obtains the user identifying information inputted from the operation input unit 24. In addition, when the print data generating portion 231 receives a print instruction from the control unit 20, the print data generating portion 231 converts the document data generated and edited in the document data generating unit 21, the document data stored in a storage unit 22, or the like into the print command to the printer 4, and then generates the print data as a print job. On this occasion, the print data generating portion 231 adds the electronic coupon obtained in the electronic coupon obtaining portion 232 and the user identifying information obtained in the user ID obtaining portion 233 to the print data as attribute data. In addition, the generated print data is sent to the management server 3 via the interface 26.

Next, the management server 3 has a function of managing a use of the printer 4 connected to the network 5. That is, the management server 3 manages the electronic coupon given in response to the user identifying information, the printing function for which the usage restriction is released by the electronic coupon, and the information on the effective range set on the electronic coupon. In addition, when the management server 3 receives the print data from the client PC 2, the management server 3 determines whether or not the received print data includes the electronic coupon and the user identifying information. When the received print data is determined to include the electronic coupon and the user identifying information, the management server 3 permits various printing functions set in the print data to be performed only within the range set in the received electronic coupon and the user identifying information. When the received print data is determined not to include the electronic coupon and the user identifying information, the management server 3 modifies the configuration of the specific printing function set in the print data in response to the usage restriction of the printing function set in the printer 4. Further, when the received print data is determined to include the electronic coupon and the user identifying information and the electronic coupon is not set in response to the user identifying information, the management server 3 modifies the configuration of the specific printing function set in the print data in response to the usage restriction of the printing function set in the printer 4. Furthermore, when the electronic coupon is determined not to have effect, the management server 3 modifies the configuration of the specific printing function set in the print data in response to the usage restriction of the printing function set in the printer 4.

The management server 3 has also a function of issuing the electronic coupon releasing the usage restriction of the specific printing function in response to the user identifying information in each printer 4 within a predetermined effective range. In this case, the electronic coupon is issued by a method in which the electronic coupon is issued by a system administrator or the like who manages the printing system 1 according to the first exemplary embodiment and by a method in which the electronic coupon is automatically issued in accordance with a predetermined rule. An available period of the electronic coupon, the usable number of times of the electronic coupon, the printing function for which the usage restriction is released by the electronic coupon, and the like are set in each of the electronic coupons, as the effective range for which the usage restriction of the printing function is released.

In addition, the management server 3 has a function of distributing the issued electronic coupon to each user who uses the client PC 2, for example, by using delivery unit of an e-mail or the like.

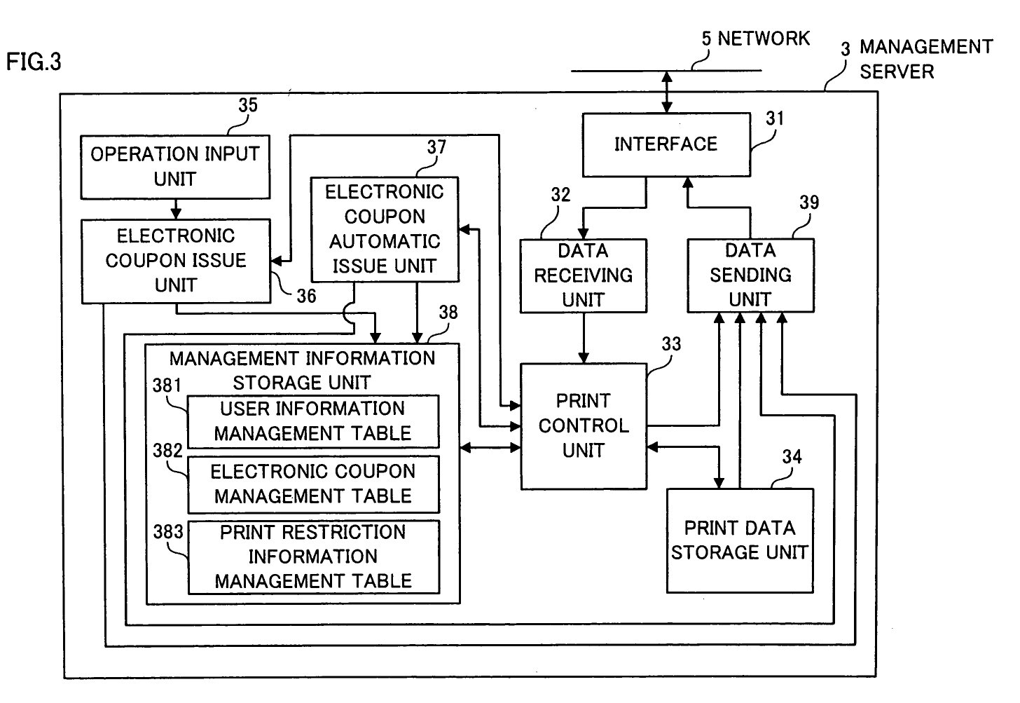

FIG. 3 is a block diagram illustrating the functional configuration of the management server 3. As shown in FIG. 3, the management server 3 includes an interface 31, a data receiving unit 32, a print control unit 33, a print data storage unit 34, an operation input unit 35, an electronic coupon issue unit 36, an electronic coupon automatic issue unit 37, a management information storage unit 38, and a data sending unit 39.

The interface 31 controls the communication with the network 5.

The data receiving unit 32 is an example of a release character string receiving unit. The data receiving unit 32 receives the print data that has been sent from the client PC 2 via the network 5, and outputs the print data to the print control unit 33.

The print data storage unit 34 receives the print data from the print control unit 33 and temporarily stores the received print data.

The management information storage unit 38 is an example of an information storage unit. The management information storage unit 38 includes a user information management table 381, an electronic coupon management table 382, and a print restriction information management table 383.

The user information management table 381 stores the information to manage the electronic coupon given in response to the user identifying information.

The electronic coupon management table 382 stores the information on the printing function for which the usage restriction is released by the electronic coupon or on the effective range set in the electronic coupon.

The print restriction information management table 383 stores the information on the printing function for which the usage restriction is imposed in the printer 4.

Various kinds of the information stored in the user information management table 381 and the electronic coupon management table 382 included in the management information storage unit 38 will be described. In the printing system 1 according to the first exemplary embodiment, it is determined whether or not the usage restriction of the specific printing function set in the printer 4 is released so as to permit performing various printing functions set in the print data on the basis of various kinds of the information stored in the user information management table 381 and the electronic coupon management table 382.

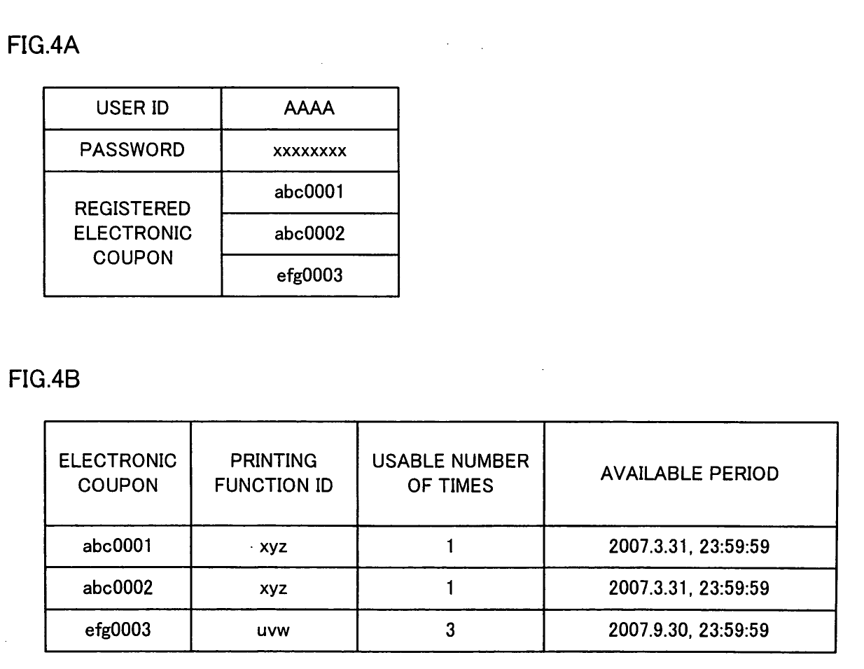

FIG. 4A and FIG. 4B are diagrams illustrating examples of information regarding the electronic coupon given to each user identifying information. FIG. 4A is a diagram illustrating an example of information to manage the electronic coupon given in response to the user identifying information stored in the user information management table 381. FIG. 4B is a diagram illustrating an example of information on the printing function for which the usage restriction is released by the electronic coupon and the effective range set in the electronic coupon stored in the electronic coupon management table 382.

In the example of the information shown in FIG. 4A, the user information management table 381 stores that the electronic coupons “abc0001,” “abc0002,” and “efg0003” are given in response to a user ID “AAAA” which is the user identifying information, and in response to a password “xxxxxxxx.”

In addition, in the example of the information shown in FIG. 4B, as the printing function for which the usage restriction is released, the printing function ID indicating a color printing, the usable number of times of the color printing function and the available period of the use of the color printing function are set in the electronic coupon and stored in the electronic coupon management table 382. For example, the printing function ID “xyz” indicating a color printing, the usable number of times of the color printing function set as “once” and the available period due to expire on “2007.3.31” (Mar. 31, 2007) are set in the electronic coupon “abc0001.” Likewise, the printing function ID “xyz” is set in the electronic coupon “abc0002,” and the usable number of times of the color printing function that is set as “once” and the available period that is set as “2007.3.31” (Mar. 31, 2007), which are set in the electric coupon “abc0002,” are stored in the electronic coupon management table 382. In addition, as the printing function for which the usage restriction is released, for example, “uvw” indicating the use of high-quality paper is set in the electronic coupon “efg0003” as the printing function ID, and the usable number of times of a high-quality paper that is set as “three” and the available period that is set as “2007.9.30” (Sep. 30, 2007), which are set in the electronic coupon “abc0002,” are stored in the electronic coupon management table 382.

By using the electronic coupon given to each kind of user identifying information, the use of the printer 4 is managed in each kind of user identifying information. In this manner, the use of the printer 4, on the basis of an individual, is strictly managed.

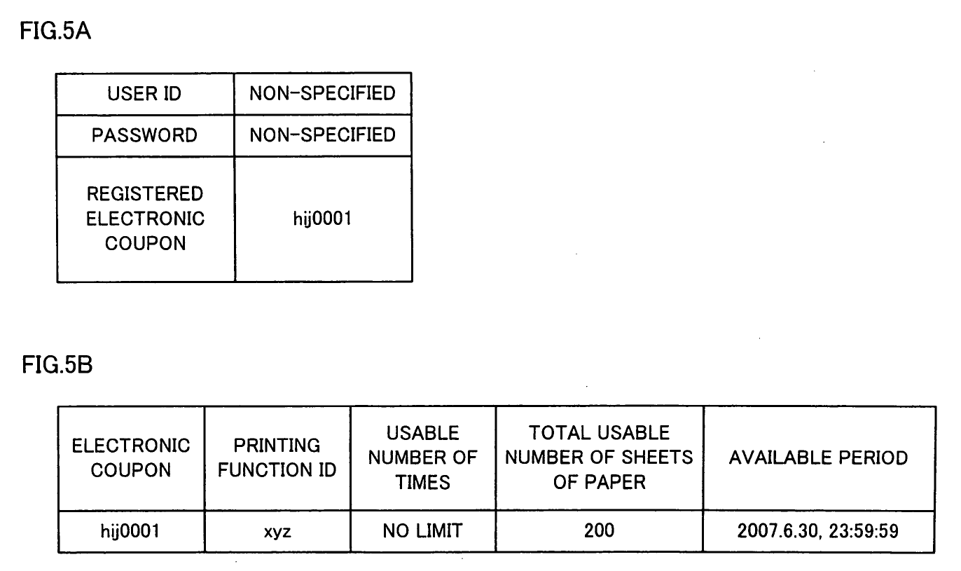

FIGS. 5A and 5B are diagrams illustrating examples of the information regarding an electronic coupon (non-specified electronic coupon) that is given not in response to the user identifying information. FIG. 5A is a diagram illustrating an example of information to manage the non-specified electronic coupon of which the user identifying information stored in the user information management table 381 is not specified. FIG. 5B is a diagram illustrating an example of information on the printing function for which the usage restriction is released by the non-specified electronic coupon and the effective range set in the electronic coupon stored in the electronic coupon management table 382.

In the example of the information shown in FIG. 5A, it is stored in the user information management table 381 that the non-specified electronic coupon “hij0001” which is usable by any user identifying information is given.

In addition, in the example of the information shown in FIG. 5B, as the printing function for which the usage restriction is released, the printing function ID indicative of color printing, the usable number of times of the color printing function, the total usable number of sheets of paper, and the available period of the use of the color printing function are set in the non-specified electronic coupon and stored in the electronic coupon management table 382. For example, the printing function ID “xyz” indicative of color printing, the usable number of times being set as “no limit,” the total usable number of sheets of paper being set as “200,” and the available period of the use due to expire on “2007.6.30” (Jun. 30, 2007) are set in the non-specified electronic coupon “hij0001.”

By using the non-specified electronic coupon that is not required to designate any user identifying information, the use of the printer 4 is managed in each non-specified electronic coupon. In this manner, it is possible to freely share the printer 4, for example, with an arbitrary group, since the user identifying information is not restricted. Moreover, it is possible to manage the printer 4 on the basis of a unit of a specific printing function with the configuration to control the total usable number of times of the specific printing function.

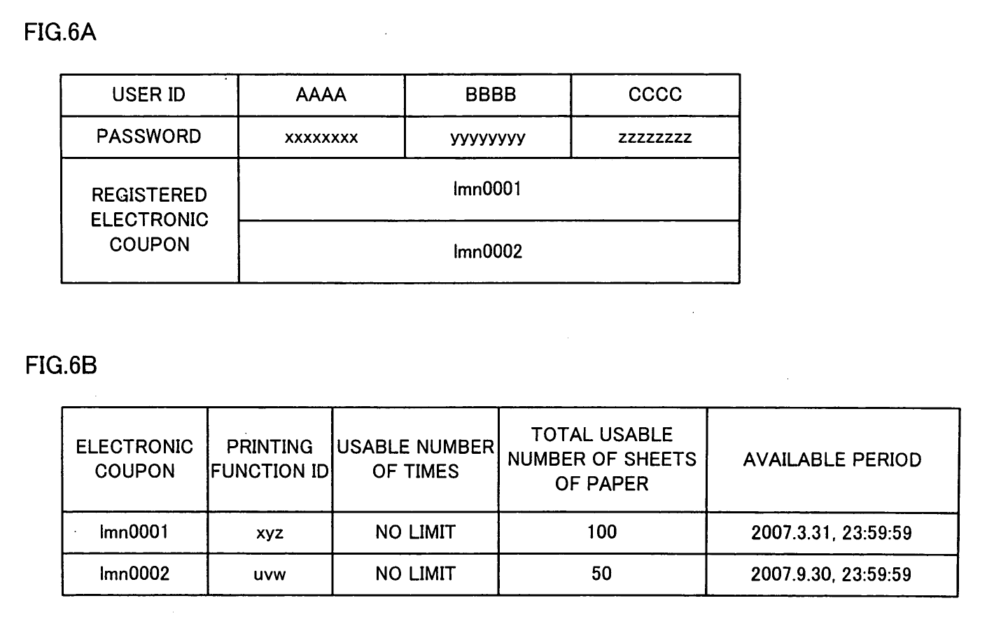

FIGS. 6A and 6B are diagrams illustrating examples of information regarding a common electronic coupon given to the plural kinds of user identifying information. FIG. 6A is a diagram illustrating an example of information for the management of the electronic coupon given in response to the user identifying information stored in the user information management table 381. FIG. 6B is a diagram illustrating an example of information on the printing function for which the usage restriction is released by the electronic coupon and the effective range set in the electronic coupon stored in the electronic coupon management table 382.

In the example of the diagram shown in FIG. 6A, the common electronic coupons “lmn0001” and “lmn0002” are given in response to, for example, three pairs of a user ID and a password, the user ID “AAAA” and the password “xxxxxxxx,” the user ID “BBBB” and the password “yyyyyyyy,” and the user ID “CCCC” and the password “zzzzzzzz,” which are kinds of user identifying information, and they are stored in the user information management table 381.

In the example of the diagram shown in FIG. 6B, as the printing function for which the usage restriction is released, the printing function ID indicating color printing, the usable number of times of the color printing function, the total usable number of sheets of paper, and the available period of the use of the color printing function are set in the electronic coupon and stored in the electronic coupon management table 382. For example, the printing function ID “xyz” indicative of color printing, the usable number of times being set as “no limit,” the total color “100” sheets of paper being permitted to be printed as the total usable number of sheets of paper, and the available period of the use due to expire on “2007.3.31” (Mar. 31, 2007) are set in the electronic coupon “lmn0001.” In addition, as the printing function for which the usage restriction is released, for example, “uvw” that indicates the use of a high quality paper is set in the electronic coupon “lmn0002” as the printing function ID, and the usable number of times of the use of a high quality paper being set as “no limit,” the available period of the use of the high quality paper being set as “2007.9.30” (Sep. 30, 2007) and the total “50” sheets of paper being permitted to be printed until “2007.9.30” (Sep. 30, 2007), which are set in the electronic coupon “lmn0002,” are stored in the electronic coupon management table 382.

By using the shared electronic coupon given to the plural kinds of user identifying information, the use of the printer 4 is managed in one group to which the plural users belong, as a whole. In this manner, it is possible to strictly manage the use of the printer 4, for example, in each group where the plural kinds of user identifying information are collected.

Next, the print control unit 33 stores the print data received from the data receiving unit 32 in the print data storage unit 34.

The print control unit 33, which is an example of a usage restriction releasing unit and a controller, determines whether or not the received print data includes the electronic coupon and the user identifying information. In addition, when the received print data is determined to include the electronic coupon and the user identifying information, the print control unit 33 determines whether or not the electronic coupon is set in response to the user identifying information, and the print attribute set by the print data is included within the effective range for which the usage restriction is released by the electronic coupon, referring to the user information management table 381 and the electronic coupon management table 382 stored in the management information storage unit 38.

When the electronic coupon is determined to be set in response to the user identifying data, and the print attribute set by the print data is included within the effective range for which the usage restriction is released by the electronic coupon, the print attribute set in the print data received from the data receiving unit 32 is applied as it is.

When the electronic coupon is determined not to include in the received print data, the print attribute set by the print data is modified to be set within the range of the printing function for which the usage restriction is imposed in the printer 4. Further, when the electronic coupon is determined to include and the electronic coupon is not set in response to the user identifying information, the print attribute set by the print data is modified to be set within the range of the printing function for which the usage restriction is imposed in the printer 4. Furthermore, when the print attribute set by the print data is determined not to be included within the effective range for which the usage restriction is released by the electronic coupon, the print attribute set by the print data is modified to be set within the range of the printing function for which the usage restriction is imposed in the printer 4.

Moreover, the print control unit 33 controls sending the print data from the data sending unit 39 to the printer 4, and controls sending the electronic coupon from the data sending unit 39 to the client PC 2 or the like.

The operation input unit 35 is used as an electronic coupon input unit when a system administrator or the like who manages the printing system 1 according to the first exemplary embodiment issues the electronic coupon to release the usage restriction of the specific printing function in each printer 4. That is, the operation input unit 35 receives the input of the electronic coupon performed by the system administrator or the like, the input of the user identifying information to which the electronic coupon is given, the input of the effective range for which the usage restriction is released by the electronic coupon or the like.

The electronic coupon issue unit 36, which is an example of a release character string generating unit, issues the electronic coupon on the basis of the user identifying information inputted from the operation input unit 35, and the effective range for which the usage restriction is released by the electronic coupon or the like. The information on the issued electronic coupon is sent to the management information storage unit 38, and stored in the user information management table 381 and the electronic coupon management table 382. In addition, under the control of the print control unit 33, the issued electronic coupon is sent to the data sending unit 39, which is an example of a release character string sending unit, and then sent to the client PC 2 via the interface 31.

The electronic coupon automatic issue unit 37, which is an example of a release character string generating unit, issues the electronic coupon on the basis of a rule set in advance by the system administrator or the like who manages the printing system 1 according to the first exemplary embodiment. The information on the issued electronic coupon is sent to the management information storage unit 38, and stored in the user information management table 381 and the electronic coupon management table 382. In addition, the issued electronic coupon is sent to the data sending unit 39 and then sent to the client PC 2 via the interface 31 under the control of the print control unit 33.

Specifically, as the rule set in advance, the electronic coupon automatic issue unit 37 issues the electronic coupon that permits the color printing, for example, for three times a month to a user or a group having, for example, the specific user identifying information on a monthly basis.

The electronic coupon issued in the electronic coupon issue unit 36 or the electronic coupon automatic issue unit 37 is distributed to a user, a group, or the like that owns the user identifying information in response to the electronic coupon by the client PC 2.

The data sending unit 39 performs sending the print data stored in the print data storage unit 34 to the printer 4 or performs sending the electronic coupon issued by the electronic coupon issue unit 36 or the electronic coupon automatic issue unit 37 to the client PC 2 based on the sending instruction from the print control unit 33.

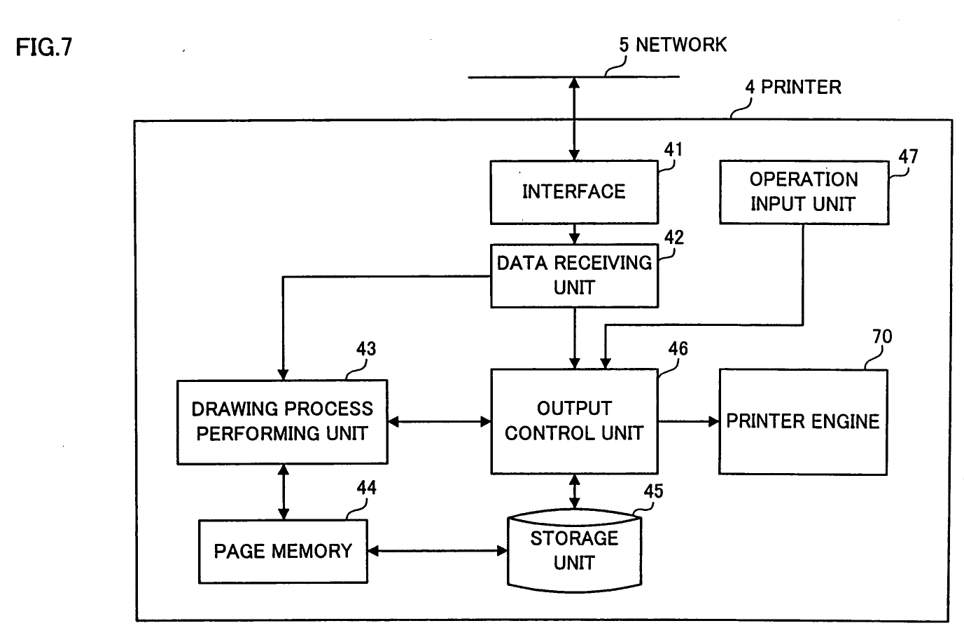

Next, the printer 4 prints the document data on a sheet of paper in the designated form on the basis of the print data sent from the management server 3. FIG. 7 is a block diagram illustrating the functional configuration of the plural printers 4 (4A to 4C). As shown in FIG. 7, the printer 4 includes an interface 41, a data receiving unit 42, a drawing process performing unit 43, a page memory 44, a storage unit 45, an output control unit 46, an operation input unit 47, and a printer engine 70.

The interface 41 controls the communication with the network 5.

The data receiving unit 42 outputs the print data received from the management server 3 via the network 5 to the drawing process performing unit 43 and the output control unit 46.

The drawing process performing unit 43 receives the print data from the data receiving unit 42. The drawing process performing unit 43 sequentially expands each object such as a character, an image, a graphic, and the like of the document data included in the print data in the page memory 44. The drawing process performing unit 43 performs decoding the coded image data and the like when the drawing process performing unit 43 expands each object in the page memory 44.

The storage unit 45 may be configured as, for example, a hard disk drive comprising plural storage areas storing the plural document data respectively. The storage unit 45 receives and stores the document data expanded in the page memory 44.

The output control unit 46 sets various printing functions in accordance with the print data received from the data receiving unit 42 on the basis of the print data sent from the management server 3. In addition, the output control unit 46 controls operations such as a sending operation of the document data from the storage unit 45 to the printer engine 70 or initiation of the print operation.

The operation input unit 47 may be configured as, for example, an operation panel. The operation input unit 47 receives, for example, the input of the initiation of the print operation by a user.

The printer engine 70 may be configured as, for example, an image forming unit using electrophotography or ink-jet. The printer engine 70 prints the document data on a sheet of paper.

Sequentially, a process sequence of the print operation performed in the printing system 1 according to the first exemplary embodiment will be described.

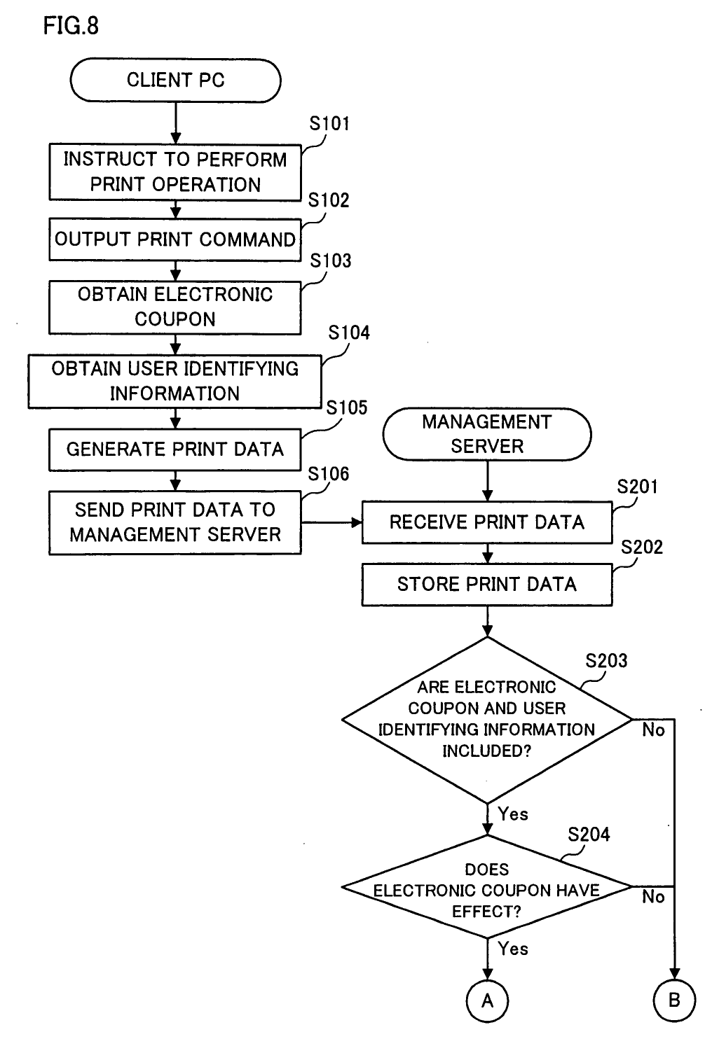

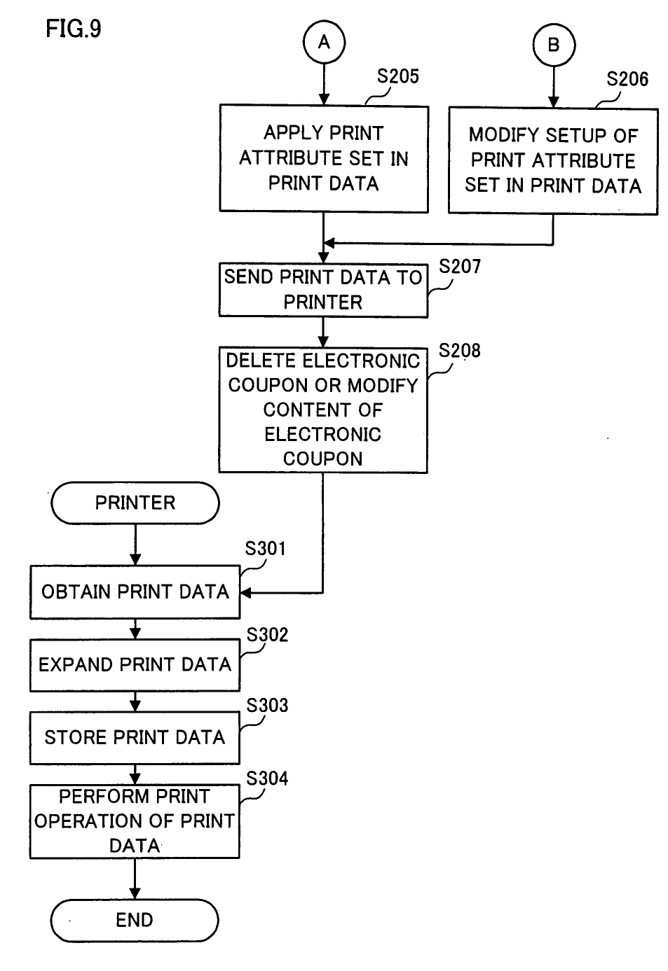

FIGS. 8 and 9 are flowcharts illustrating an example of a process sequence of the print operation in the printing system 1 according to the first exemplary embodiment. As shown in FIGS. 8 and 9, first of all, in the client PC 2, when a user instructs to perform the print operation of predetermined document data, for example, the predetermined document data generated in the document data generating unit 21 or the predetermined document data stored in the storage unit 22 from the operation input unit 24 (S101), the control unit 20 outputs a print command of these document data to the printer driver 23 (S102).

In the printer driver 23 receiving the print command from the control unit 20, when the usage restriction of the specific printing function in the printer 4 designated for performing the print operation is set and the user intends to perform the print operation after releasing the usage restriction, the electronic coupon obtaining portion 232 obtains the electronic coupon (S103). In addition, the user ID obtaining portion 233 obtains the user identifying information (S104).

Specifically, in the steps S103 and S104, when the printer driver 23 receives the print command from the control unit 20, the printer driver 23 requests the control unit 20 to display the print setup dialog box (printing function setup unit) to set various printing functions in the printer 4. The control unit 20 receives the request from the printer driver 23 and displays the print setup dialog box on the display unit 25.

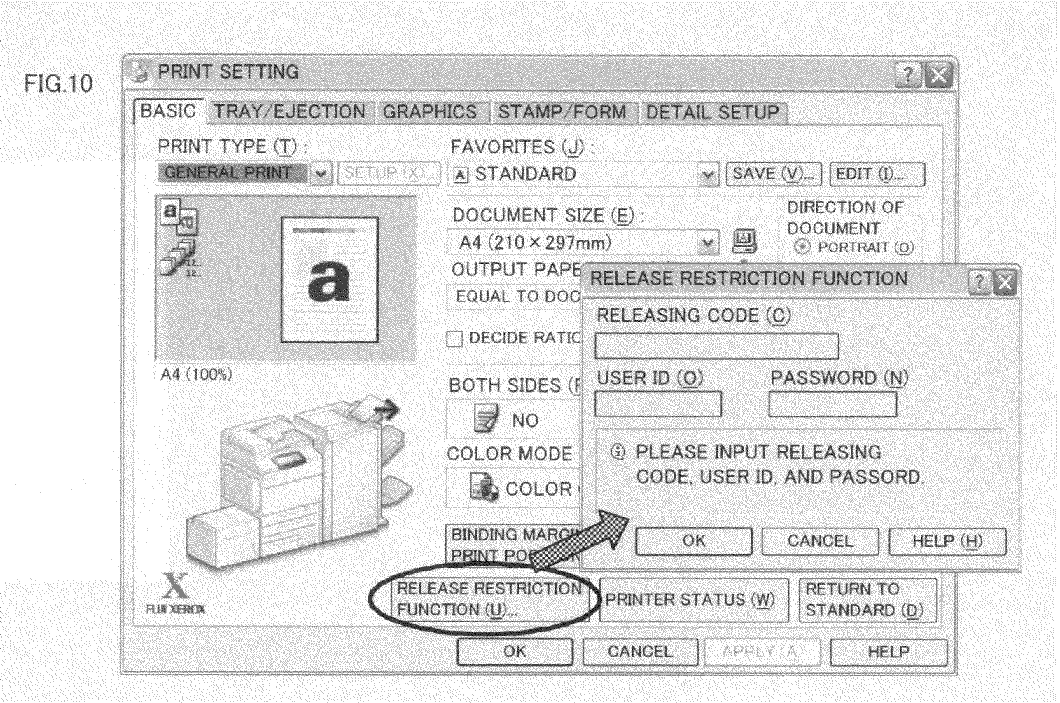

FIG. 10 is a diagram illustrating an example of the print setup dialog box displayed on the display unit 25. When a user intends to perform the print operation for which the usage restriction of the specific printing function is released in the printer 4, the user clicks the column of the “release a restriction function (U)” from a “basic” tab of the print setup dialog box shown in FIG. 10 to display the “release the restriction function” dialog box, in addition to setting various printing functions. In addition, when the “release the restriction function” dialog box shown in FIG. 10 is displayed, the user inputs the electronic coupon in the column of the “releasing code (C)” corresponding to the step S103, and further inputs the user ID in the column of the “user ID (O)” and the password in the column of the “password (N)” corresponding to the step S104 respectively from the operation input unit 24.

As the user ID and the password, which is the user identifying information, for example, the user ID and the password used at the time of logging in the client PC 2, the account ID or the password used at the time of accessing the network 5, and the like may be used. In this case, the user ID, the password, and the like used at the time of logging in the client PC 2 may be set and registered in advance as the user ID and the password used at the time of releasing the restriction function in the print operation. Consequently, it may be also configured that only the electronic coupon is inputted in the column of the “releasing code (C),” and the user ID and the password, which are kinds of user identifying information, are automatically inputted in the “release the restriction function” dialog box.

In addition, it is possible to configure in a manner that the plural electronic coupons may be inputted simultaneously in the “release the restriction function” dialog box. Consequently, it may be configured that plural different printing functions are released simultaneously.

Subsequently, in the printer driver 23, the print data generating portion 231 generates the print data including the document data, the electronic coupon, the user ID, the password (user identifying information), and the attribute data setting various print forms (printing functions) inputted from the print setup dialog box by a user, and the like (S105).

In addition, the print data generated in the step S105 are sent from the printer driver 23 to the management server 3 via the interface 26 (S106).

When the management server 3 receives the print data from the client PC 2 (S201), the data receiving unit 32 sends the print data to the print control unit 33. In addition, the print control unit 33 temporarily stores the print data in the print data storage unit 34 (S202).

The print control unit 33 determines whether or not the electronic coupon and the user identifying information are included in the received print data (S203).

When the print control unit 33 determines that the electronic coupon and the user identifying information are included in the received print data in the step S203, the print control unit 33 determines whether or not performing the print operation of the various print functions set in the print data is permitted on the basis of the received electronic coupon and the user identifying information. That is, by referring to the user information management table 381 and the electronic coupon management table 382 stored in the management information storage unit 38, the print control unit 33 determines whether or not the received electronic coupon is set in response to the received user identifying information, and the print control unit 33 determines whether or not the received electronic coupon has the effect for performing the print operation of the various printing functions set in the print data by releasing the usage restriction of the specific printing function set in printer 4. (S204).

When the print control unit 33 determines that the electronic coupon is set in response to the user identifying information and that the electronic coupon has the effect in the step S204, the print control unit 33 applies various printing functions (print attributes) set in the print data as they are (S205).

On the other hand, when the print control unit 33 determines that the electronic coupon and the user identifying information are not included in the received print data in the step S203, the print control unit 33 modifies the setup of the print attribute set in the print data so as to be in response to the usage restriction of the specific printing function set in the printer 4, by referring to the print restriction information management table 383 of the management information storage unit 38 (S206). Likewise, when the print control unit 33 determines that the electronic coupon is not set in response to the user identifying information or that the electronic coupon has no effect in the step S204, the print control unit 33 modifies the setup of the print attribute set in the print data so as to be in response to the usage restriction of the specific printing function set in the printer 4, by referring to the print restriction information management table 383 of the management information storage unit 38 (S206). That is, the print control unit 33 reads the print data stored in the print data storage unit 34, and forces to modify the read print data into the print attribute adjusted to the usage restriction of the specific printing function set in the printer 4.

Subsequently, the print control unit 33 reads the print data from the print data storage unit 34 at a predetermined time, and then sends the print data from the data sending unit 39 to printer 4 via the interface 31 (S207). When the plural print data are stored in the print data storage unit 34, the print control unit 33 determines sequence of outputting each print data.

When the electronic coupon releases the usage restriction of the specific printing function set in the printer 4 in the step S205, the print control unit 33 deletes the used electronic coupon or modifies the content of the electronic coupon in the user information management table 381 of the management information storage unit 38 (S208). For example, when the usable number of times is set to one time as the effective range set in the electronic coupon, the usable number of times has been already exceeded. Therefore, the electronic coupon is deleted from the user information management table 381. On the other hand, when the usable number of times is set to three times, the print control unit 33 modifies the content of the electronic coupon stored in the user information management table 381 so as to subtract one from the predetermined usable number of times in connection with the use this time. Likewise, when the total usable number of sheets of paper is set as the effective range set in the electronic coupon and the number of the printed sheets of paper is equal to the total usable number of sheets of paper, the electronic coupon is deleted from the user information management table 381. In addition, when the number of the printed sheets of paper is within the range of the total usable number of sheets of paper, the content of the electronic coupon stored in the user information management table 381 is modified, such that the number of the printed sheets of paper is subtracted from the total usable number of sheets of paper.

In this manner, since the electronic coupon is unusable at the next print time because of the deletion of the electronic coupon or the modification of the content of the electronic coupon, the print operation in which the usage restriction of the printing function is released is unperformable or the print operation limited to the effective range set in the electronic coupon of which the content is modified is performed. Consequently, since the use of the printer 4 is limited to the effective range given in the initial electronic coupon, it is possible to reflect the usage history of the electronic coupon.

And then, when the printer 4 obtains the print data from the management server 3 via the network 5 (S301), the data receiving unit 42 outputs the print data to the drawing process performing unit 43. The drawing process performing unit 43 sequentially expands each object, such as a character, an image and the like of the document data in the print data in the page memory 44 (S302). When the drawing process performing unit 43 expands the document data in the page memory 44, the drawing process performing unit 43 decodes the coded image data. The drawing process performing unit 43 stores the document data expanded in the page memory 44 in the storage unit 45 (S303).

In addition, the data receiving unit 42 outputs the print data to the output control unit 46. The output control unit 46 sets the print form on the basis of the attribute data (print attribute) of the print data. Subsequently, the output control unit 46 reads the document data stored in the storage unit 45 to perform the print operation of the document data in the printer engine 70 in accordance with the set print form (S304).

As explained above, in the printing system 1 according to the first exemplary embodiment, when the usage restriction of one or plural specific printing functions are set in the printer 4 to be designated for performing the print operation, the electronic coupon given in advance (release character string) is inputted at the time of performing the print operation. When the inputted electronic coupon has the effect to release the usage restriction of one or plural specific printing functions set in the printer 4, the usage restriction is released to apply the printing function (print attribute) set in the print data as it is. On the other hand, when the inputted electronic coupon has no effect, the print attribute set in the print data is modified so as to be in response to the usage restriction of the printing function set in the printer 4.

In addition, the used electronic coupon that has the effect is deleted from the management information storage unit 38, or the content of the electronic coupon is modified in accordance with the effective range given in the electronic coupon. Consequently, since the electronic coupon is deleted and thus not used at the next print operation, the print operation in which the usage restriction of the printing function is released is unperformable, or since the content of the electronic coupon is modified, the print operation limited to the effective range set in the electronic coupon of which the content is modified is performed at the next print operation. For this reason, the use of the printer 4 is limited to the initial effective range given in the electronic coupon.

In this manner, in the printing system 1 according to the first exemplary embodiment, it is possible to release the usage restriction of the specific printing function set in the printer 4 within the effective range set in the electronic coupon. For this reason, the system administrator or the like who manages the printing system 1 may manage the printing system 1 in a flexible manner, by setting the range of releasing the usage restriction of the printing function for individual electronic coupon in response to the various usage of the printer 4 by a user.

In addition, since the system administrator or the like may set a unit to release the usage restriction in various aspects such as a unit of a user, a unit of a specific group, or a unit of a specific printing function, it is possible to manage the printing system 1 in a flexible manner in accordance with the various usage aspects of the printer 4.

Since the electronic coupon may be automatically distributed under a predetermined rule by the system administrator or the like, the printing system 1 is not required to be directly monitored by the system administrator or the like all the time, and thus it is possible to reduce the burden of managing. In addition, since the content of the usage restriction set in the printer 4 may be easily modified, it is possible to manage the printing system 1 easily. Further, it is possible to unify the management by issuing the electronic coupon and managing the electronic coupon simultaneously in the management server 3.

### Second Exemplary Embodiment

In the printing system 1 according to the first exemplary embodiment, the print control unit 33 refers to the information and the like on the effective range of the electronic coupon stored in the management server 3. The printing system 1 performs the print operation in which the usage restriction of the printing function is released in the case that the electronic coupon inputted in the client PC 2 has the effect of releasing the usage restriction of the specific printing function of the printer 4. In a printing system 10 according to a second exemplary embodiment, the configuration that the print operation in which the usage restriction of the printing function is released is performed in a copy machine 6 or the printer 4 will be described for the case that the electronic coupon inputted in the copy machine 6 or the printer 4 has the effect of releasing the usage restriction of the specific printing function with reference to the information and the like on the stored effective range of the electronic coupon, while the information and the like on the effective range of an electronic coupon are stored in the copy machine 6 or the printer 4 in advance. In addition, the same references numerals and signs will be used in the same configuration as the first exemplary embodiment and the detailed description will be omitted.

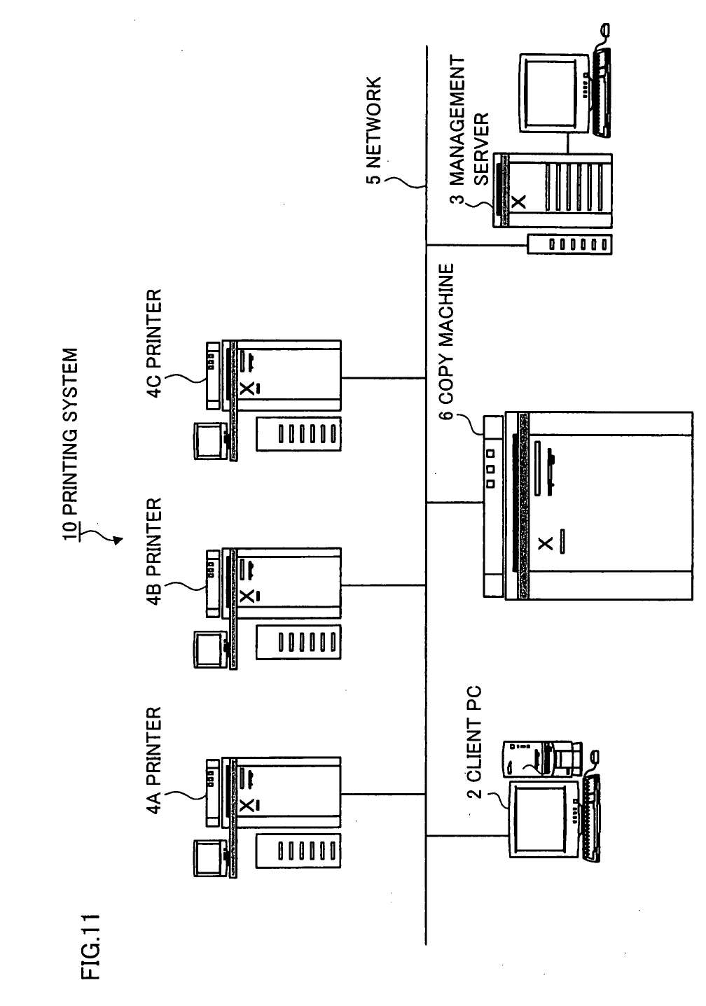

FIG. 11 is a diagram illustrating the overall configuration of the printing system 10 according to the second exemplary embodiment. The printing system 10 shown in FIG. 11 is configured so that the client PC (personal computer) 2, the plural printers 4 (4a to 4c), the copy machine 6, and the management server 3 are connected via the network 5 to communicate interactively. The client PC (personal computer) 2 is an example of a terminal. The plural printers 4 (4A to 4C) are examples of image forming units to perform print operation of the document data generated or the like in the client PC 2 on a sheet of paper. The copy machine 6 is an example of an image forming unit to copy a document on a sheet of paper. The management server 3 manages the use of the copy machine 6 and the printer 4 by the client PC 2. That is, in the printing system 10 according to the second exemplary embodiment, a configuration in which the copy machine 6 is connected to the network 5 in addition to the configuration according to the first exemplary embodiment is adopted. In addition, a configuration in which one client PC 2 and one copy machine 6 are connected is shown in FIG. 11, but the plural client PCs 2 and the plural copy machines 6 will be connected.

In the printing system 10 according to the second exemplary embodiment, the copy machine 6 and each of the printers 4A to 4C store the information to manage the electronic coupon given in response to a user identifying information, the information on a printing function for which the usage restriction is released by the electronic coupon or on the effective range set in the electronic coupon, and the information on the specific printing function for which the usage is restricted in the copy machine 6 or in each of the printers 4. In addition, when the copy operation in the copy machine 6 or when the print operation in each of the printers 4A to 4C are performed, on condition that the electronic coupon inputted in the copy machine 6 or the printer 4 has the effect of releasing the usage restriction of a specific printing function as the result of referring to the information on the effective range set in the electronic coupon described above, the copy operation and the print operation for which the usage restriction of the printing function is released is performed in the copy machine 6 and the printers 4.

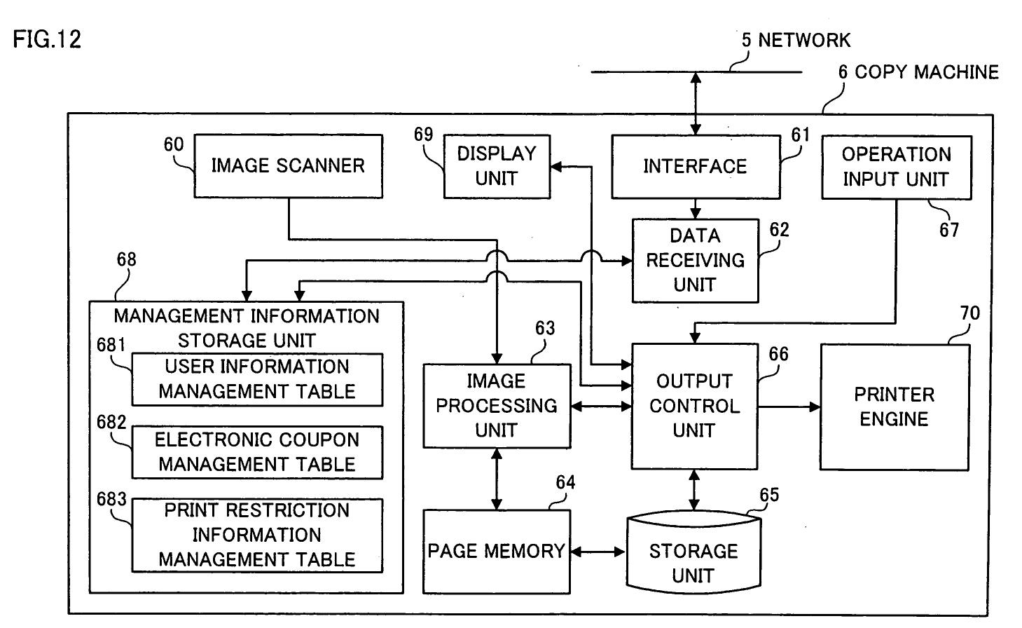

FIG. 12 is a block diagram illustrating the functional configuration of the copy machine 6 according to the second exemplary embodiment. As shown in FIG. 12, the copy machine 6 includes an image scanner 60, an interface 61, a data receiving unit 62, an image processing unit 63, a page memory 64, a storage unit 65, an output control unit 66, an operation input unit 67, a management information storage unit 68, a display unit 69, and a printer engine 70.

The image scanner 60, which is an example of an image reading unit, has a function of scanning reflectance data of each color element from a document. Specifically, the image scanner 60 illuminates a document placed on a platen glass (not shown in figures) and reads a light reflected from the document as the reflectance data of each color of R (red), G (green), and B (blue) by using an image pickup device, such as a CCD. In addition, the image scanner 60 outputs the scanned reflectance data of each color element to the image processing unit 63.

The interface 61 controls the communication with the network 5. The data receiving unit 62 outputs the information on the electronic coupon received from the management server 3 via the network 5 to the management information storage unit 68.

The image processing unit 63 generates image data by performing predetermined image processing such as shading correction, displacement correction, brightness or color space conversion, gamma correction, and the like of the reflectance data of each color element scanned by the image scanner 60. In addition, the image data in which the image processing is performed are converted into the image data of four (4) colors, which are yellow (Y), magenta (M), cyan (C), and black (B), and then expanded in the page memory 64.

The storage unit 65 may be configured as, for example, a hard disk drive having plural storage areas storing each of the plural image data. The storage unit 65 receives and stores the image data expanded in the page memory 64.

The operation input unit 67 may be configured as, for example, an operation panel. The operation input unit 67, for example, receives the electronic coupon inputted by a user, various printing functions set by a user or the like.

The output control unit 66 sets various printing functions in accordance with the input of the setup received from the operation input unit 67. In addition, the output control unit 66 controls the sending of the image data from the storage unit 65 to the printer engine 70, the initiation of the print operation or the like.

The printer engine 70 may be configured as, for example, an image forming unit using electrophotography, ink-jet, or the like. The printer engine 70 prints the document data on a sheet of paper.

The management information storage unit 68 includes a user information management table 681, an electronic coupon management table 682, and a print restriction information management table 683. The user information management table 681 stores the information to manage the electronic coupon given in response to the user identifying information. The electronic coupon management table 682 stores the printing function for which the usage restriction is released by the electronic coupon or the information on the effective range set in the electronic coupon. The print restriction information management table 683 stores the information on the specific printing function of which the usage restriction is imposed in the copy machine 6.

The information similar to the one stored in the management information storage unit 38 according to the first exemplary embodiment is stored in the management information storage unit 68 (see FIGS. 4 to 6 for reference).

The description of the configuration of the printer 4 according to the second exemplary embodiment will be omitted. The configuration of the printer 4 according to the second exemplary embodiment is similar to that of the printer 4 according to the first exemplary embodiment, and the printer 4 according to the second exemplary embodiment includes the management information storage unit 68 which is similar to that of the copy machine 6 according to the second exemplary embodiment in addition to the configuration of the printer 4 according to the first exemplary embodiment.

The management server 3 has also a function of issuing the electronic coupon releasing the usage restriction of the specific printing function in response to the user identifying information in the copy machine 6 or each printer 4 within a predetermined effective range. In this case, the electronic coupon is issued by a method in which the electronic coupon is issued by a system administrator or the like who manages the printing system 10 according to the second exemplary embodiment and by a method in which the electronic coupon is automatically issued in accordance with a predetermined rule. The available period of the electronic coupon, the usable number of times of the electronic coupon, and the printing function for which the usage restriction is released by the electronic coupon or the like are set in each of the electronic coupons, as the effective range for which the usage restriction of the printing function is released.

In addition, the management server 3 has a function of distributing the issued electronic coupon to each user via the client PC 2, for example, by using delivery unit of an e-mail or the like.

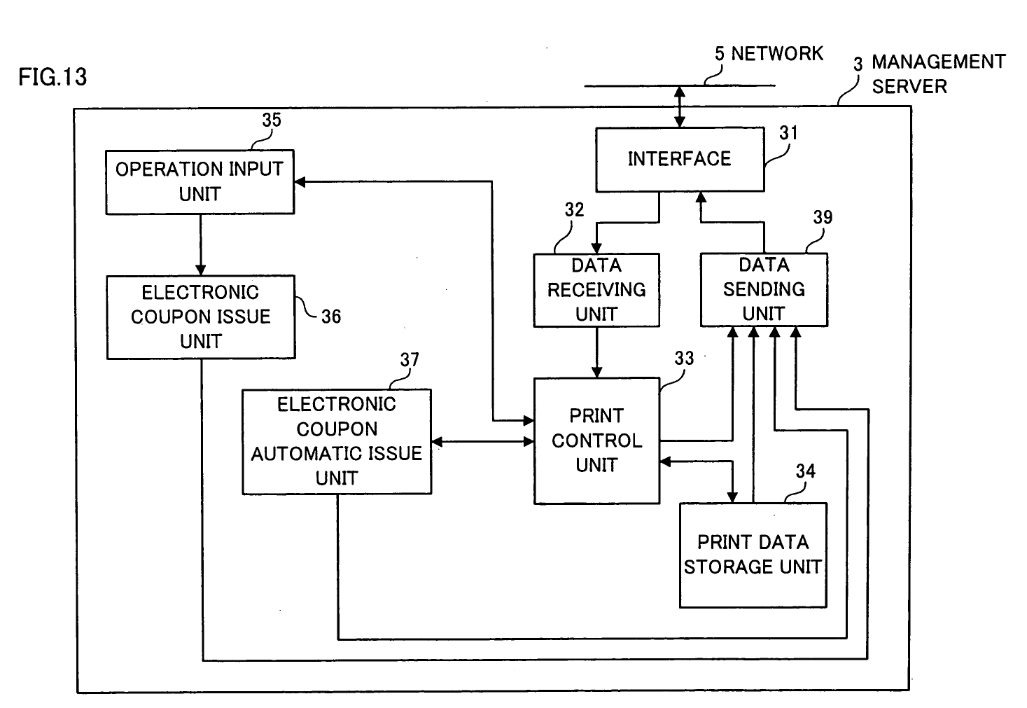

FIG. 13 is a block diagram illustrating the functional configuration of the management server 3. As shown in FIG. 13, the management server 3 includes an interface 31, a data receiving unit 32, a print control unit 33, a print data storage unit 34, an operation input unit 35, an electronic coupon issue unit 36, an electronic coupon automatic issue unit 37, and a data sending unit 39.

The interface 31 controls the communication with the network 5.

The data receiving unit 32 receives the print data that has been sent from the client PC 2 via the network 5, and outputs the print data to the print control unit 33.

The print data storage unit 34 receives the print data from the print control unit 33 and temporarily stores the received print data.

The print control unit 33 stores the print data received from the data receiving unit 32 in the print data storage unit 34. Further, the print control unit 33 controls sending the print data from the data sending unit 39 to the printers 4, sending the information on the electronic coupon from the data sending unit 39 to the copy machine 6 and printers 4, and sending the electronic coupon from the data sending unit 39 to the client PC 2, or the like.

The operation input unit 35 is used as an electronic coupon input unit when a system administrator or the like who manages the printing system 10 according to the second exemplary embodiment issues the electronic coupon to release the usage restriction of the specific printing function in the copy machine 6 or each of the printers 4. That is, the operation input unit 35 receives the input of the electronic coupon performed by the system administrator or the like, the input of the user identifying information to which the electronic coupon is given, the input of the effective range for which the usage restriction is released by the electronic coupon or the like.

The electronic coupon issue unit 36 issues the electronic coupon on the basis of the user identifying information inputted from the operation input unit 35, and the effective range for which the usage restriction is released by the electronic coupon or the like. The electronic coupon and the information on the electronic coupon are sent to the data sending unit 39. In addition, under the control of the print control unit 33, the issued electronic coupon is sent from the data sending unit 39 to the client PC 2 via the interface 31. The information on the electronic coupon is sent from the data sending unit 39 to the copy machine 6 and the printers 4 via the interface 31.

The electronic coupon automatic issue unit 37 issues the electronic coupon on the basis of the rules set in advance by a system administrator or the like who manages the printing system 10 according to the second exemplary embodiment. The issued electronic coupon and the information on the electronic coupon are sent to the data sending unit 39. The issued electronic coupon is sent from the data sending unit 39 to the client PC 2 via the interface 31 under the control of the print control unit 33. In addition, the information on the electronic coupon is sent from the data sending unit 39 to the copy machine 6 and the printers 4 via the interface 31.

Specifically, as the rule set in advance, the electronic coupon automatic issue unit 37 periodically issues the electronic coupon that permits a color printing, for example, for three times a month to a user or a group having, for example, the specific user identifying information on a monthly basis.

The electronic coupon issued in the electronic coupon issue unit 36 or the electronic coupon automatic issue unit 37 is distributed to a user, a group, or the like that owns the user identifying information in response to the electronic coupon by the client PC 2.

The data sending unit 39 performs sending the print data stored in the print data storage unit 34 to the printers 4, sending the electronic coupon issued by the electronic coupon issue unit 36 or the electronic coupon automatic issue unit 37 to the client PC 2, and sending the information on the electronic coupon to the copy machine 6 and printers 4 based on the sending instruction from the print control unit 33.

Subsequently, the print operation performed in the printing system 10 according to the second exemplary embodiment will be described. An example of copy operation of the copy machine 6 will be described here.

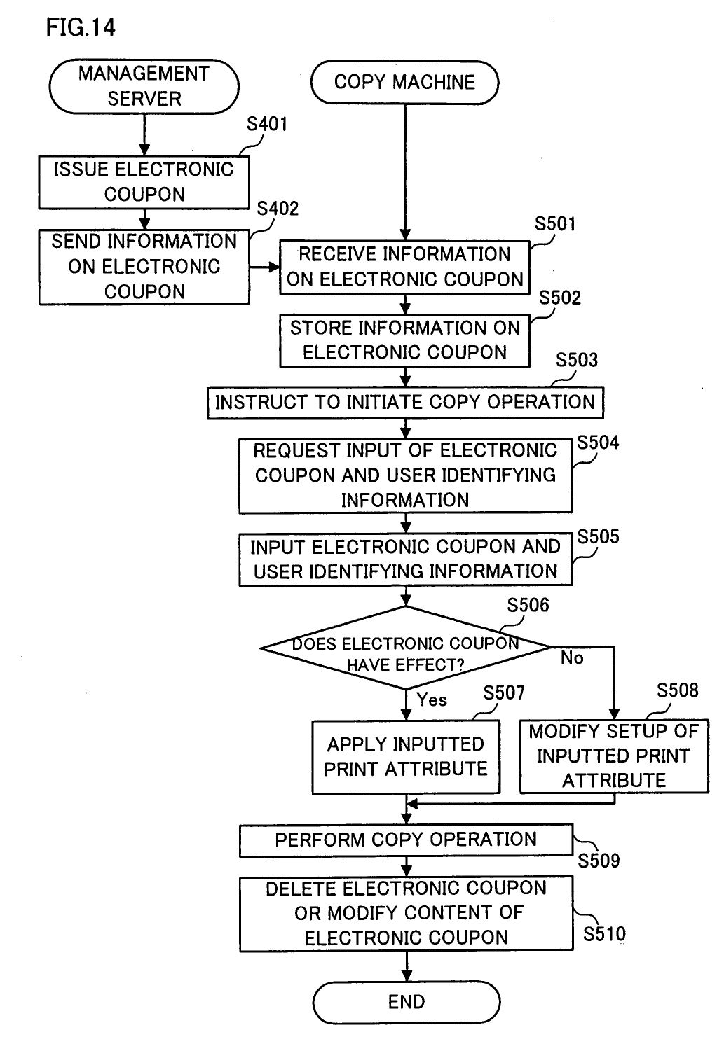

FIG. 14 is a flowchart illustrating an example of a process sequence of the copy operation in the printing system 10 according to the second exemplary embodiment. As shown in FIG. 14, first of all, the management server 3 issues the electronic coupon in the electronic coupon issue unit 36 or the electronic coupon automatic issue unit 37 (S401). The information on the issued electronic coupon is sent to the copy machine 6 and the printer 4 (S402).

When the copy machine 6 obtains the information on the electronic coupon issued from the management server 3 (S501), then the copy machine 6 stores the information on the electronic coupon in the management information storage unit 68 (S502). Specifically, the copy machine 6 stores the information to manage the electronic coupon given in response to the user identifying information in the user information management table 681, and stores the information on the printing function for which the usage restriction is released by the electronic coupon and the information on the effective range set in the electronic coupon in the electronic coupon management table 682.

In the copy machine 6, after instructed to initiate the copy operation of the document from the operation input unit 67 by the user (S503), the output control unit 66 controls the display unit 69 so as to display the message of requesting the input of the electronic coupon and the user identifying information in the case that the usage restriction for a specific printing function is set in the copy machine 6 and the printing function for which the usage restriction is set is included in the printing function inputted from the operation input unit 67 (S504).

In addition, when the electronic coupon and the user identifying information are inputted from the operation input unit 67 by the user (S505), the output control unit 66 determines whether or not the various printing functions set from the operation input unit 67 are permitted on the basis of the inputted electronic coupon and the user identifying information. That is, by referring to the user information management table 681 and the electronic coupon management table 682 stored in the management information storage unit 68, the output control unit 66 determines whether or not the inputted electronic coupon is set in response to the user identifying information and has the effect to release the usage restriction of the specific printing function set in the copy machine 6 so as to perform the copy operation with the various inputted printing functions (S506).

In the step S506, when the output control unit 66 determines that the electronic coupon is set in response to the user identifying information and has the effect, the output control unit 66 applies various printing functions (print attributes) inputted from the operation input unit 67 as it is (S507).

Alternatively, in the step S506, when the output control unit 66 determines that the electronic coupon inputted from the operation input unit 67 is not set in response to the user identifying information or that the electronic coupon has no effect, the output control unit 66 modifies the inputted print attribute so as to be in response to the usage restriction of the specific printing function set in the copy machine 6, by referring to the print restriction information management table 683 of the management information storage unit 68 (S508). That is, the output control unit 66 forces to modify the print attribute inputted from the operation input unit 67 into the printing function adjusted to the usage restriction.

Subsequently, the output control unit 66 instructs the printer engine 70 to perform the print operation of the image data stored in the storage unit 65 (S509).

In addition, in the case that the electronic coupon releases the usage restriction of the specific printing function set in the copy machine 6 in the step S506, the output control unit 66 deletes the used electronic coupon or modifies the content of the electronic coupon in the user information management table 681 of the management information storage unit 68 (S510). For example, when the usable number of times is set to once as the effective range set in the electronic coupon, the usable number of times has been already exceeded. Therefore, the electronic coupon is deleted from the user information management table 681. On the other hand, when the usable number of times is set to three times, the output control unit 66 modifies the content of the electronic coupon stored in the user information management table 681 so as to subtract one from the predetermined usable number of times in connection with the use this time. Likewise, when the total usable number of sheets of paper is set as the effective range set in the electronic coupon and the number of the printed sheets of paper is equal to the total usable number of sheets of paper, the electronic coupon is deleted from the user information management table 681. In addition, when the number of the printed sheets of paper is within the range of the total usable number of sheets of paper, the content of the electronic coupon stored in the user information management table 681 is modified, such that the number of the printed sheets of paper is subtracted from the total usable number of sheets of paper.

In this manner, since the electronic coupon is unusable at the next copy operation because of the deletion of the electronic coupon or the modification of the content of the electronic coupon, the copy operation in which the usage restriction of the printing function is released is unperformable or the copy operation limited to the effective range set in the electronic coupon of which the content is modified is performed. Consequently, since the use of the copy machine 6 is limited to the effective range given in the initial electronic coupon, the use of the copy machine 6 is surely managed by the electronic coupon.

Except for sending and receiving the print data between the printer 4 and the client PC 2, print operation of the printer 4 is performed in a similar manner.

In the printing system 10 according to the second exemplary embodiment, as described above, in the case that the usage restriction of one specific printing function or plural specific printing functions is set in the copy machine 6 or the printer 4 designated for performing the print operation, the electronic coupon given in advance (release character string) is inputted, when the copy or print operation is performed. By referring to the information on the effective range of the electronic coupon stored in the copy machine 6 or the printer 4, it is determined whether or not the inputted electronic coupon has the effect to release the usage restriction of one or plural specific printing functions set in the copy machine 6 or the printer 4. In addition, when the inputted electronic coupon has the effect, the usage restriction is released to apply the inputted printing function (print attribute) as it is. On the other hand, when the inputted electronic coupon has no effect, the print attribute set in the printer data is modified so as to be in response to the usage restriction of the printing function set in the copy machine 6 or the printer 4.

In addition, the used electronic coupon that has the effect is deleted from the management information storage unit 68, or the content of the electronic coupon is modified in accordance with the effective range given in the electronic coupon. Consequently, since the electronic coupon is deleted and thus not used at the next copy or print operation, the print operation in which the usage restriction of the printing function is released is unperformable, or since the content of the electronic coupon is modified, the print operation limited to the effective range set in the electronic coupon of which the content is modified is performed. For this reason, the use of the copy machine 6 or the printer 4 is limited to the initial effective range given in the electronic coupon at the next copy or print operation.

In this manner, in the printing system 10 according to the second exemplary embodiment, it is possible to release the usage restriction of the specific printing function set in the copy machine 6 or the printer 4 within the effective range set in the electronic coupon, by referring to the information on the effective range of the electronic coupon stored in the copy machine 6 or the printer 4 and the like. For this reason, the system administrator or the like who manages the printing system 10 may manage the printing system 10 in a flexible manner, by setting the range of releasing the usage restriction of the printing function for individual electronic coupon in response to various usages of the copy machine 6 or the printer 4 by a user.

In addition, since the system administrator or the like may set a unit to release the usage restriction in various aspects such as a unit of a user, a unit of a specific group, or a unit of a specific printing function, it is possible to manage the printing system 10 in a flexible manner in accordance with the various usage aspects of the printer 4.

Since the electronic coupon may be automatically distributed under a predetermined rule set by the system administrator or the like, the printing system 10 is not required to be directly monitored by the system manager or the like all the time, and thus it is possible to reduce the burden of managing. In addition, since the content of the usage restriction set in the copy machine 6 or the printer 4 may be easily modified, it is possible to manage the printing system 10 easily.

Furthermore, in the exemplary embodiments, it is also possible to record a program corresponding to the flowcharts shown in FIG. 8, 9 and FIG. 14 in an information recording media such as a flexible disk, or acquire and record the program corresponding to the flowcharts by a network such as the Internet or by telephone communication, the program is read out and executed by using a general-purpose computer such as a microcomputer or the like and thereby makes the computer function as the data receiving unit 32 and the print control unit 33 according to the exemplary embodiments.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A printing system comprising:
an image forming unit including a usage restriction of a predetermined print attribute set in print data for performing a print operation;
a release character string receiving unit that receives input of a release character string for releasing the usage restriction of the print attribute included in the image forming unit within an effective range given in advance; and
a usage restriction releasing unit that releases the usage restriction of the image forming unit on condition that the release character string received in the release character string receiving unit has effect of releasing the usage restriction of the print attribute included in the image forming unit.

2. The printing system according to claim 1, further comprising an information storage unit that stores information on the release character string received in the release character string receiving unit and information on the effective range set in the release character string.

3. The printing system according to claim 2, wherein the usage restriction releasing unit determines whether or not the release character string received in the release character string receiving unit has effect of releasing the usage restriction of the print attribute in the image forming unit on the basis of the information stored in the information storage unit.

4. The printing system according to claim 3, wherein the usage restriction releasing unit releases the usage restriction and utilizes the print attribute set in the print data when the release character string is determined to have the effect of releasing the usage restriction, and alternatively the usage restriction releasing unit modifies the print attribute set in the print data in response to the usage restriction when the release character string is determined not to have the effect of releasing the usage restriction.

5. The printing system according to claim 3, wherein the usage restriction releasing unit deletes the release character string stored in the information storage unit from the information storage unit when the usage restriction releasing unit releases the usage restriction of the print attribute in the image forming unit.

6. The printing system according to claim 3, wherein the usage restriction releasing unit updates the effective range set in the release character string stored in the information storage unit when the usage restriction releasing unit releases the usage restriction of the print attribute in the image forming unit.

7. The printing system according to claim 1, further comprising a release character string generating unit that generates the release character string.

8. The printing system according to claim 7, wherein the release character string generating unit decides, as the effective range, at least any one of a usable number of times of the release character string, an available period of the release character string, and a kind of the print attribute released by the release character string when the release character string generating unit generates the release character string.

9. The printing system according to claim 7, further comprising a release character string sending unit that sends the release character string generated in the release character string generating unit to a terminal sending the print data to the image forming unit.

10. The printing system according to claim 7, wherein the release character string generating unit automatically generates the release character string on the basis of a rule set in advance.

11. A print management apparatus comprising:
a release character string receiving unit that receives input of a release character string for releasing a usage restriction of a predetermined print attribute set in print data within an effective range given in advance;
an information storage unit that stores information on the release character string and information on the effective range set in the release character string; and
a controller that determines whether or not the release character string received in the release character string receiving unit has effect of releasing the usage restriction of the print attribute on the basis of the information stored in the information storage unit, releases the usage restriction of the print attribute and utilizes the print attribute set in the print data when the release character string is determined to have the effect of releasing the usage restriction, and modifies the print attribute set in the print data in response to the usage restriction when the release character string is determined not to have the effect of releasing the usage restriction.

12. The print management apparatus according to claim 11, wherein the controller deletes the release character string stored in the information storage unit when the usage restriction is released and the print attribute set in the print data is utilized.

13. The print management apparatus according to claim 11, wherein the controller updates the effective range set in the release character string when the usage restriction is released and the print attribute set in the print data is utilized.

14. The print management apparatus according to claim 11, further comprising a release character string generating unit that generates the release character string.

15. The print management apparatus according to claim 14, wherein the release character string generating unit automatically generates the release character string on the basis of a rule set in advance.

16. A printing method comprising:
receiving input of a release character string that releases a usage restriction within an effective range given in advance, the usage restriction being of a predetermined print attribute set in print data;
storing information on the release character string and information on the effective range set in the release character string in an information storage unit;
determining whether or not the received release character string has effect of releasing the usage restriction of the print attribute on the basis of the information stored in the information storage unit; and
releasing the usage restriction of the print attribute and utilizing the print attribute set in the print data when the release character string is determined to have the effect of releasing the usage restriction, and modifying the print attribute set in the print data in response to the usage restriction when the release character string is determined not to have the effect of releasing the usage restriction.

17. A computer readable medium storing a program causing a computer to execute a process for print management, the process comprising:
receiving an input of a release character string that releases a usage restriction of a predetermined print attribute set in print data within an effective range given in advance;
storing information on the release character string and information on the effective range set in the release character string in an information storage unit;
determining whether or not the received release character string has effect of releasing the usage restriction of the print attribute on the basis of the information stored in the information storage unit; and
releasing the usage restriction of the print attribute and utilizing the print attribute set in the print data when the release character string is determined to have the effect of releasing the usage restriction, and modifying the print attribute set in the print data in response to the usage restriction when the release character string is determined not to have the effect of releasing the usage restriction.

18. The computer readable medium according to claim 17, further comprising deleting the release character string stored in the information storage unit when the usage restriction is released and the print attribute set in the print data is applied.

19. The computer readable medium according to claim 17, further comprising updating the effective range set in the release character string when the usage restriction is released and the print attribute set in the print data is applied.

20. The computer readable medium according to claim 17, further comprising generating the release character string.
